(19) United States
(12) Patent Application Publication
(10) Pub. No.: US 2014/0174128 A1
(43) Pub. Date: Jun. 26, 2014

(54) METHOD TO WELD TOGETHER PIECESS THAT CONTAIN SUBSTRATUM USING A FOCUSED LASER BEAM

(71) Applicant: Primoceler Oy, Tampere (FI)

(72) Inventor: Antti Maattanen, Tampere (FI)

(21) Appl. No.: 14/133,564

(22) Filed: Dec. 18, 2013

(30) Foreign Application Priority Data
Dec. 21, 2012 (FI) 2012 0420

(51) Int. Cl. C03B 23/20

(52) U.S. Cl. CPC C03B 23/20
USPC 65/29.11

(57) ABSTRACT

A method of welding together pieces that contain substratum includes focusing a laser beam to their common surface between them so the focal point energy melts material in both pieces at the same time. The focused laser beam is set to move in relation of the pieces that do not move in relation to each other with such a velocity that the melted material when getting hard forms a united welded seam. When the surfaces to be joined together are three-dimensional the height position of the laser beam focal point is altered following the measuring results of a light beam that advances in front of the laser beam so that it focuses all the time with a certain accuracy to the common surface.

### BACKGROUND

1. Field

The object of this invention is a method to weld together pieces that contain substratum by focusing a laser beam to their common surface area between them and so the focal point energy melts material in both pieces at the same time and the focused laser beam is set to move in relation of the pieces that do not move in relation to each other with such a velocity that the melted material when getting hard forms a pieces uniting welded seam.

The usage place of the invention is especially such uniting by welding of pieces where the common surfaces areas are three-dimensional. This diversion from the plane surface can be caused by an intentional plane formation or of a diversion of a surface that has been intended to be a plane surface into a three-dimensional plane for some reason. The pieces to be united can consist totally or partly of substratum(s). For instance we can mention the pieces that contain a substratum layer and a conducting layer joined to it in such a way that these conducting layers are against each other in the common surface between the pieces. Metals are generally used as the material of the conducting layers. The substratum can largely be any material or material combination where melting and getting hard again can happen by a focused laser beam. They can be homogenous or composed of areas and/or layers of different materials. As an example we can mention glass and/or silicon substratum semiconductor components that are used in micro electronics. Using the method of the invention, for instance detectors and optic components can be closed and packaged hermetically.

2. Brief Description of Related Developments

According to the known technique the welding of the before mentioned pieces takes place by batched welding where the height position of the focal point of the focused laser beam is corrected to correspond the changed height position of the common surface of the advancing path of the laser beam. In other words, for instance to obtain a unanimous circle welding by one go is not possible using the methods of the known technique when it is question about joining together three-dimensional surfaces by welding.

The before mentioned known technique has been described for instance in the patent publication FI20105539. It is presented in this publication mainly how to weld together pieces by laser beam using the batched welding. It is presented in the publication also how to form a circle welding by a focused laser beam but in this case it is question about a totally planar welding area that is the common surface between the pieces to be welded. The publication does not present any other solution to weld the pieces together by a laser beam where the common surface is not planar—other than batch welding.

It is known that such planar welding objects do not exist in practice very much that for instance real semiconductor components could be produced using the method that has been brought forth in the before mentioned publication using circle welding without repositioning the laser beam focal point midst the welding process.

The greatest disadvantage of the known technique can be seen that getting a unanimous, tight three-dimensional welding joint is not at all possible by its methods in one uninterrupted go. This disadvantage is culminated in many different ways: The welding is slow and thus the costs are high, and also the tightness of the welding is questionable. To obtain a hermetically sealed joint is in practice impossible by using the known technique because a hole of one micrometer in the joint lets the helium out.

### SUMMARY

The intention of this invention is to obtain such a method that disadvantages of the known technique are avoided. It is characteristic for the method according to the invention what has been presented in the characterizing part of the claim 1.

A notable advantage is obtained by the method according to the invention in that all the welding made by a focused laser beam where the welding does not proceed all the time in the same level, can be obtained by one continuous go. When there is no need to perform the welding in different goes and change the laser beam focal point height position between these goes the welding process is considerably faster than according to the methods of the known technique. This means that the production is faster and more efficient and thus a more lucrative economic result is obtained.

Another notable advantage is obtained when the three-dimensional surfaces are welded together using the method according to the invention it renders always when needed a completely tight join, from short joint up to full ring circle welding. Naturally, the method allows also the welding of a planar surface. It does not have any meaning whatsoever, whether the 3D surfaces to be welded are deviating suitably from the planar surface or whether they are intended to be planar surfaces but for some physical reason more or less 3D surfaces during the welding process.

In this document, the term “height value” means the distance of a certain point from a certain comparison level, like for instance a datum level, independently of in what position this comparison level is.

### BRIEF DESCRIPTION OF THE DRAWINGS

The invention is described in the drawings of this application as follows:

FIG. 1 presents an equipment configuration in one welding method according to the invention general view in 3D,

FIG. 2 presents the cross-section that has been presented in FIG. 1 in the place A-A,

FIG. 3 presents the action of welding using the method of the invention, as presented in FIG. 2 from point z,

FIGS. 4 and 5 present chart like one situation seen from above, where there is in process a circle wending using the method of the invention.

### DETAILED DESCRIPTION OF THE DISCLOSED EMBODIMENTS

Next there is a description of one advantageous application of the invention referring to the before mentioned figures.

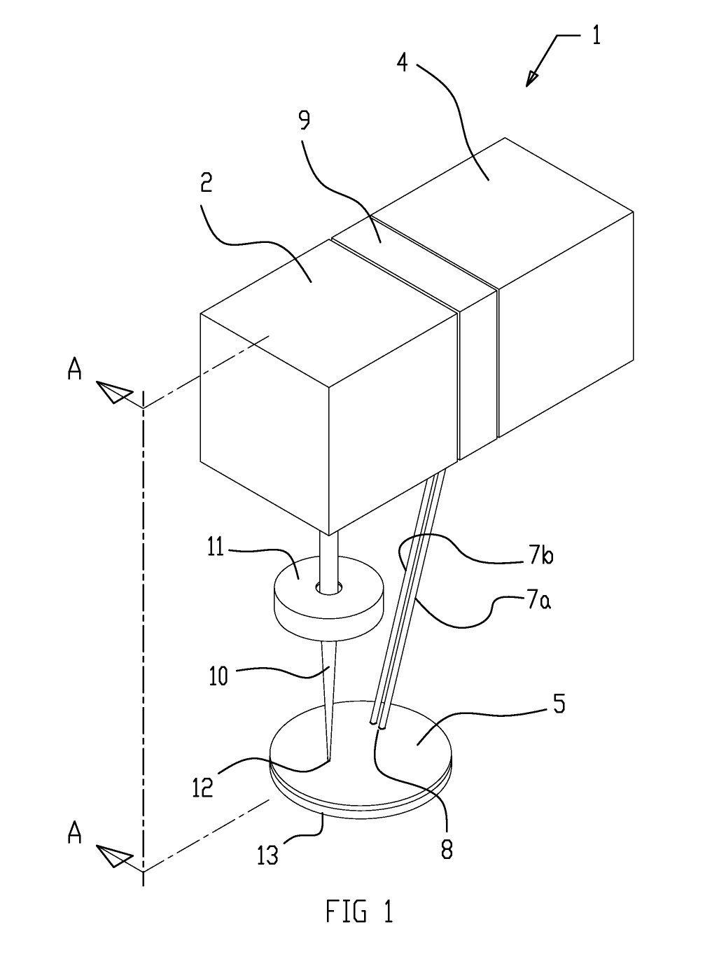

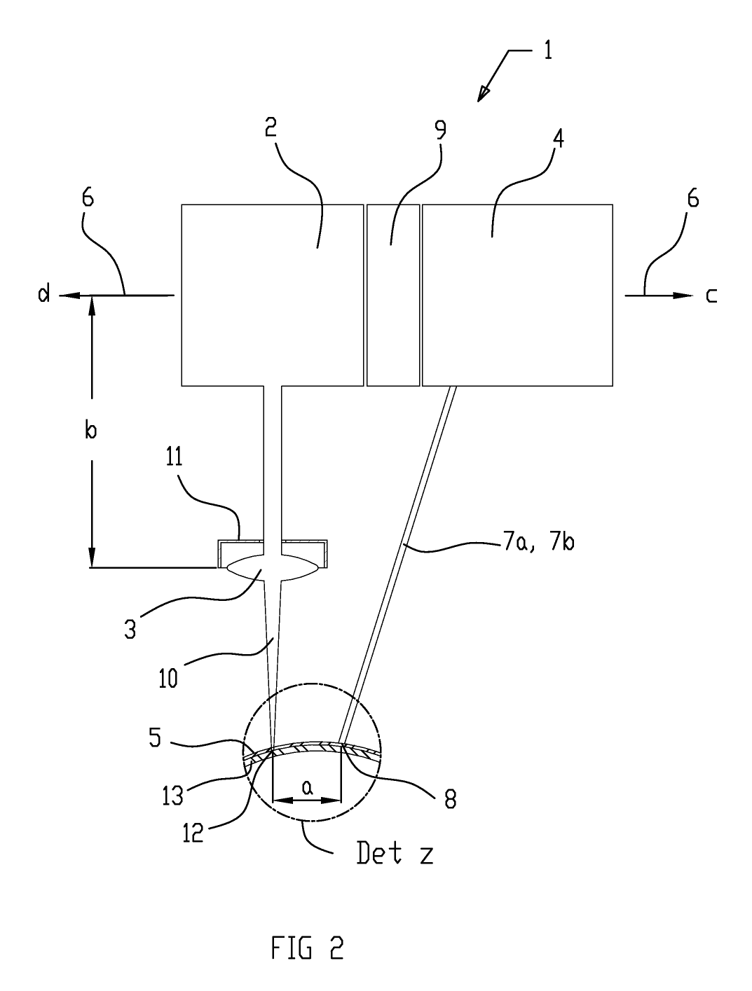

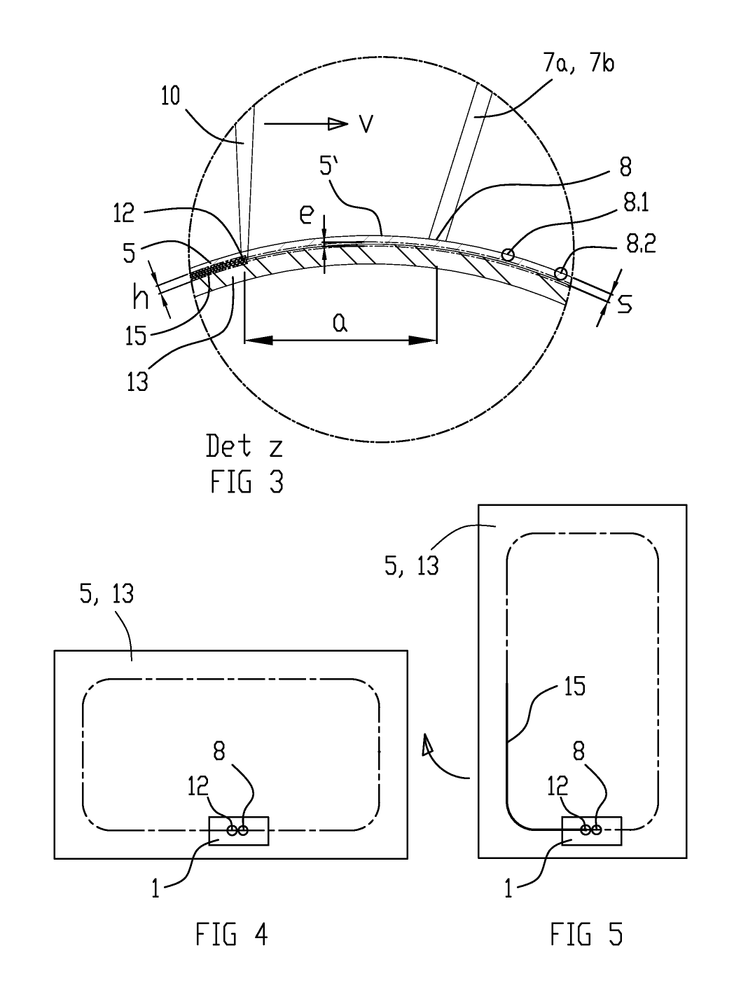

An equipment configuration is described in FIG. 1, that is ready to perform the welding together of two pieces like to join together two glass plates in their common surface e. FIG. 2 presents cross-section A-A and it can be seen, that above the pieces to be welded, first piece 5 and the second piece 13 there is an uniform working unit 1 that composes of a laser device 2, a computer 9 and a measuring device 4. During the action of welding the focused laser beam 10 is moving in relation to the pieces 5, 13 that are to be welded together, into the direction c with a velocity v (FIGS. 2 and 3) and in a similar movement there is also the measurement device 4 measuring the first 3D surface of the surface 5′ that is receiving and transmitting light beam 7a, 7b. In a certain point of the first surface 5′, like for instance in the point 8 the light beam 7a deflects and returns as the light beam 7b back to the measure device 4. The measure device registers the measure information that it got on the welding path in certain interval points 8.1, 8.2, and so on. The processor of the computer 9 calculates basing on the color of the light beam 7b the height position of these points in relation to a certain base level 6 and these values are stored into the computer 9 memory. When the focused laser beam 10 comes after the measuring event to the point of a certain measure point 8, 8.1, 8.2 etc., the computer calculates basing on the height position information of the point in question a corrected height position information and feeds it into the lens 3 regulating unit 11. The corrected height position information is the downright distance of the point in question from the base level 6 plus the thickness s of the first peace 5. The regulating unit 11 of the lens 3 positions the lens 3 at such a height that the focused laser beam 10 going through of the first piece 5 has its focal point 12 in the common surface e of both pieces 5, 13 and thus the energy of the laser beam melts material of both pieces 5, 13 and as these melted materials get mixed and again hard so the before mentioned pieces get welded together with a welded seam 15.

In FIG. 3, a situation can be seen where the welding is in process in the weld path following before the above mentioned point 8 calculated points. The regulating unit 11 changes if necessary the height position of the lens 3 at every measured point and thus the welding advances following each position of the common surface e with an accuracy that can be achieved by changing the height position at the successive measured points. The measure event of the points advances in this situation the distance a ahead of the welding event so that the focused laser beam 10 would not cause disturbance for the measuring event.

The before described system of measuring certain points and changing of the height position of the laser beam focal point is described in the Finnish Patent Application nr 20110379. This present application is an additional application of the mentioned application, that is to say, in this application we bring forth further developed results for the invention of that previous application.

When the welding path deviates sideways from the right line and a change of direction is needed for the measuring light beams 71, 7b and the focused laser beam 10 in relation to the pieces to be welded 5, 13, it can be done by turning the pieces 5, 13 in relation to the work unit 1 or vice versa. It is also possible to turn both of the before mentioned and it is essential that in connection of the method according to the invention, an equipment construction is used that contains the tools to make the necessary direction changes so that the light beams 7a, 7b and the focused laser beam 10 advance essentially one after the other following a certain welding path.

In FIGS. 4 and 5 there is a diagrammatic picture from above about a situation where the pieces 5, 13 to be welded are turned as the circle welding is in process. FIG. 4 presents a situation at the beginning of the welding and the FIG. 5 shows the situation where the welding seam 15 has advanced on the welding path over one corner in a piece that is rectangle with rounded corners.

In the method according to the invention, the size of the focused point of the laser beam 10 is in the size range of 1-10 μm, but it can be in certain cases different from these limit values. The before mentioned size focal point makes in practice a welded seam 15 height h of the size range 40-200 μm.

The pieces 5, 13 to be joined together can have a large range of thicknesses. For instance a first piece 5 of glass can be at least 3 mm maximum and the other piece 13 also of glass does not have a size limit.

The invention is especially suitable for glass and/or semiconductor substratum, like silicon, technical glass, melted silicon oxide, borosilicate, chalk glass, sapphire, ceramic materials like zirconium oxide, LiTaO and so on, and also the combinations of these materials can be welded. The conducting materials of the pieces 5, 13 can be for instance of chrome, copper, silver, gold, molybdenum, indium tin oxide, or a combination of these.

When the pieces 5, 13 to be joined together contain conducting parts the method according to the invention can be used to join them and/or to protect them against outside oxygen or humidity. As an example of this kind of pieces, semiconductor chips and micro chips can be mentioned where the thicknesses of the conducting metals are about 0.1-5 μm. It is worth noticing that in these and also in other pieces to be welded the laser beam 10 is directed through the first piece 5 substratum and so this material must be transparent for the laser beam 10 wave length that is used.

It should be noted that although this application presents one advantageous exemplary embodiment of the present invention, it is not intended to limit broader use of the invention in any way; all alternatives for implementing the invention are possible within the inventive idea defined by the claims.

1. A Method to weld together pieces like glass containing substratum and/or half conductor substratum like the first piece and the second piece according to which method:
a. the pieces are put one upon other in such a way that a common surface is formed between them,
b. a laser beam is focused to the common surface between the pieces so that focal point energy of the laser beam melts material of both of the pieces at the same time,
c. the focused laser beam is set to move in relation to pieces to be welded, which pieces do not move in relation to each other, with such a velocity that the melted material when getting hard forms a welded seam that joins the pieces together, wherein
d. the height position of the focal point of the focused laser beam is changed during the welding stepwise so that this height position follows essentially the height position of the common surface of the pieces to be welded together with an accuracy of certain steps,
e. the height position of the focal point is changed so that
i. the light beams of the measuring device measure the height position information of the first surface of the first piece in certain points in a certain distance in front of the focused laser beam essentially on the advancement path of the laser beam and the measuring device feeds this information to the computer,
ii. the computer treats the measurement information from the points so that basing on this information the height positions of these points are achieved in relation to a certain level, like for instance in relation to the basic level,
iii. the computer feeds at least with about the thickness of the first piece i.e. the distance between the upper side and the down side, corrected height values to the regulating unit that changes the distance of the lens or lens combination from a certain level, like for instance basic level so that the focal point of the laser beam is focused at each of the measured points to the height position that is achieved by taking the actual point value and adding to it at least about the thickness of the first piece, that is in the common surface area,
f) the advancing direction of the light beams and the focused laser beam in relation to the pieces is changed during the welding process by turning the general work unit 1 and/or the work unit 1 of the pieces in the level direction of the basic level or by some other method that is suitable to the situation when making a welding other than sideways directly advancing welding, like circle welding.

2. The method according to claim 1 wherein it is used to join by welding any such first piece to another piece that contains such substratum that is transparent in the wave lengths of the laser beam that is used in the method.

3. The method according to claim 1 wherein the height of the welded seam that is achieved by it is 30-250 μm.

4. The method according to claim 1 wherein when joining to the second piece the first piece in the side where the laser beam is coming the thickness of the first piece is 30-3000 μm.
